(19) United States
(12) Patent Application Publication
(10) Pub. No.: US 2025/0337885 A1
(43) Pub. Date: Oct. 30, 2025

(54) BLOCK VECTOR REFINEMENT FOR INTRA TEMPLATE MATCHING PREDICTION AT SUBBLOCK LEVEL

(71) Applicant: Tencent America LLC, Palo Alto, CA (US)

(72) Inventors: Biao WANG, San Jose, CA (US); Xin ZHAO, San Jose, CA (US); Roman CHERNYAK, Santa Clara, CA (US); Shan LIU, San Jose, CA (US); Lien-fei CHEN, Palo Alto, CA (US); Madhu PERINGASSERY KRISHNAN, Mountain View, CA (US)

(73) Assignee: Tencent America LLC, Palo Alto, CA (US)

(21) Appl. No.: 19/260,028

(22) Filed: Jul. 3, 2025

Related U.S. Application Data
(63) Continuation of application No. PCT/US2024/026072, filed on Apr. 24, 2024.
(60) Provisional application No. 63/462,233, filed on Apr. 26, 2023.

(51) Int. Cl. H04N 19/105; H04N 19/159; H04N 19/176

(52) U.S. Cl. CPC H04N 19/105; H04N 19/159; H04N 19/176

(57) ABSTRACT

An apparatus of video decoding includes processing circuitry. The processing circuitry is configured to receive coded information of a current block. The coded information indicates that the current block is coded based on intra template matching prediction (intraTMP). The processing circuitry is configured to determine a plurality of candidate block vectors (BVs) in a first search range for a first subblock of the current block. The first search range is determined based on a BV of the current block. The plurality of candidate BVs indicates a plurality of candidate prediction subblocks for the first subblock of the current block. The processing circuitry is configured to determine a refined BV of the first subblock from the plurality of candidate BVs that is determined in the first search range based on the intraTMP. The processing circuitry is configured to reconstruct the first subblock based on the refined BV of the first subblock.

### INCORPORATION BY REFERENCE

The present application is a continuation of International Application No. PCT/US2024/026072, filed on Apr. 24, 2024, which claims the benefit of priority to U.S. Provisional Application No. 63/462,233, “BLOCK VECTOR REFINEMENT FOR INTRA TEMPLATE MATCHING PREDICTION AT SUBBLOCK LEVEL” filed on Apr. 26, 2023. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of processing visual media data is provided. In the method, a bitstream of the visual media data is processed according to a format rule. In an example, the bitstream includes coded information of a current block in a current picture. The coded information indicates that the current block is coded in an intra template matching prediction (intraTMP) mode. The format rule specifies that a prediction block of the current block is predicted from a plurality of candidate prediction blocks defined in an initial search range based on the current block being coded in the intraTMP mode. The prediction block is referenced by a block vector (BV) of the current block. The format rule specifies that a first plurality of candidate BVs is determined in a first search range for a first subblock of the current block and a second plurality of candidate BVs is determined in a second search range for a second subblock of the current block. The format rule specifies that the initial search range, the first search range, and the second search range include different search regions. The format rule specifies that the first search range and the second search range are determined based on the BV of the current block. The format rule specifies that the first plurality of candidate BVs of the first subblock indicates a plurality of candidate prediction subblocks for the first subblock. The format rule specifies that the second plurality of candidate BVs of the second subblock indicates a plurality of candidate prediction subblocks for the second subblock. The format rule specifies that a refined BV of the first subblock is determined from the first plurality of candidate BVs based on the intraTMP mode. The format rule specifies that a refined BV of the second subblock is determined from the second plurality of candidate BVs based on the intraTMP mode. The format rule specifies that the first subblock is processed based on the refined BV of the first subblock, and the second subblock is processed based on the refined BV of the second subblock.

In an example, the format rule specifies that a cost value between a template of the first subblock and a template of each of the plurality of candidate prediction subblocks of the first subblock is determined. The format rule specifies that one of the first plurality of candidate BVs of the first subblock is determined as the refined BV of the first subblock that corresponds to a minimum cost value of the cost values between the template of the first subblock and the templates of the plurality of candidate prediction subblocks that corresponds to the first plurality of candidate BVs of the first subblock.

In an example, the format rule specifies that the BV of the current block is defined by a first coordinate BVx and a second coordinate BVy. The format rule specifies that the first search range is defined by a top left coordinate (BVx−OffsetL1, BV1y−OffsetT1) and a bottom right coordinate (BVx+OffsetR1, Bvy+OffsetB1), where the OffsetL1, the OffsetT1, the OffestR1, and the OffsetB1 are pre-defined constants. The format rule specifies that the second search range is defined by a top left coordinate (BVx−OffsetL2, Bvy−OffsetT2) and a bottom right coordinate (BVx+OffsetR2, Bvy+OffsetB2), where the OffsetL2, the OffsetT2, the OffestR2, and the OffsetB2 are pre-defined constants. The format rule specifies that the OffsetL2, the OffsetT2, the OffestR2, and the OffsetB2 are different from at least one corresponding offset of the first search range.

In an example, a boundary of the first search range is within a boundary of the initial search range.

In an example, a boundary of the first search range is beyond a boundary of the initial search range.

According to another aspect of the disclosure, a method of video encoding is provided. In the method, a prediction block of a current block in a current picture is determined from a plurality of candidate prediction blocks defined in an initial search range based on intraTMP mode. The prediction block is referenced by a BV of the current block. A first plurality of candidate BVs is determined in a first search range for a first subblock of the current block. The initial search range and the first search range include different search regions. The first search range is determined based on the BV of the current block. The first plurality of candidate BVs of the first subblock indicates a plurality of candidate prediction subblocks for the first subblock. A refined BV of the first subblock is determined from the first plurality of candidate BVs based on the intraTMP mode. The first subblock is encoded in a bitstream based on the refined BV of the first subblock.

In an example, a cost value between a template of the first subblock and a template of each of the plurality of candidate prediction subblocks is determined. One of the first plurality of candidate BVs of the first subblock is determined as the refined BV of the first subblock that corresponds to a minimum cost value of the cost values between the template of the first subblock and the templates of the plurality of candidate prediction subblocks that corresponds to the first plurality of candidate BVs of the first subblock.

In an example, the BV of the current block is defined by a first coordinate BVx and a second coordinate BVy. The first search range is defined by a top left coordinate (BVx−OffsetL1, BV1y−OffsetT1) and a bottom right coordinate (BVx+OffsetR1, BVy+OffsetB1). The OffsetL1, the OffsetT1, the OffestR1, and the OffsetB1 are pre-defined constants.

In an example, a second plurality of candidate BVs is determined in a second search range for a second subblock of the current block. The second search range is determined based on the BV of the current block. A refined BV of the second subblock is determined from the second plurality of candidate BVs based on the intraTMP mode. The second search range is different from the first search range.

According to yet another aspect of the disclosure, an apparatus for video decoding is provided. The apparatus includes processing circuitry. The processing circuitry is configured to receive a bitstream including coded information of a current block in a current picture. The coded information indicates that the current block is coded based on intraTMP mode in which a prediction block of the current block is determined based on a cost value between a template of the current block and a template of the prediction block, where the prediction block is referenced by a BV of the current block. The processing circuitry is configured to determine a first plurality of candidate BVs in a first search range for a first subblock of the current block. The first search range is determined based on the BV of the current block. The first plurality of candidate BVs indicates a plurality of candidate prediction subblocks for the first subblock of the current block. The processing circuitry is configured to determine a refined BV of the first subblock from the first plurality of candidate BVs based on the intraTMP mode. The processing circuitry is configured to reconstruct the first subblock based on the refined BV of the first subblock.

In an example, the processing circuitry is configured to determine a cost value between a template of the first subblock and a template of each of the plurality of candidate prediction subblocks. The processing circuitry is configured to determine one of the first plurality of candidate BVs of the first subblock as the refined BV of the first subblock that corresponds to a minimum cost value of the cost values between the template of the first subblock and the templates of the plurality of candidate prediction subblocks that corresponds to the first plurality of candidate BVs of the first subblock.

In an example, the BV of the current block is defined by a first coordinate BVx and a second coordinate BVy, and the first search range is defined by a top left coordinate (BVx−OffsetL1, BV1y−OffsetT1) and a bottom right coordinate (BVx+OffsetR1, BVy+OffsetB1). The OffsetL1, the OffsetT1, the OffestR1, and the OffsetB1 are pre-defined constants.

In an example, the processing circuitry is configured to determine a second plurality of candidate BVs in a second search range for a second subblock of the current block, where the second search range is determined based on the BV of the current block. The processing circuitry is configured to determine a refined BV of the second subblock from the second plurality of candidate BVs based on the intraTMP mode, where the second search range is different from the first search range.

In an example, the second search range is defined by a top left coordinate (BVx−OffsetL2, BVy−OffsetT2) and a bottom right coordinate (BVx+OffsetR2, BVy+OffsetB2). The OffsetL2, the OffsetT2, the OffestR2, and the OffsetB2 are pre-defined constants and different from at least one corresponding offset of the first search range.

In an example, the BV of the current block is determined from a plurality of candidate BVs of the current block that is defined in an initial search range according to the intraTMP mode. A boundary of the first search range is beyond a boundary of the initial search range.

In an example, the BV of the current block is defined in an initial search range according to the intraTMP mode, and a boundary of the first search range is within a boundary of the initial search range.

In an example, a resolution of the BV of the current block is at one of a first integral pel and a first sub-pel. A resolution of the BV of the first subblock is at one of a second integral pel and a second sub-pel. The first integral pel includes one of 1-pel, 2-pel, 4-pel, and 8-pel, and the first sub-pel includes one of ½-pel, ¼-pel, and ⅛-pel. The second integral pel includes one of 1-pel, 2-pel, 4-pel, and 8-pel, and the second sub-pel includes one of ½-pel, ¼-pel, and ⅛-pel.

In an example, the processing circuitry is configured to determine a prediction subblock of the first subblock from the plurality of candidate prediction subblocks. The prediction subblock of the first subblock is indicated by the refined BV. The processing circuitry is configured to determine reconstructed samples of the first subblock as (i) samples of the prediction subblock of the first subblock or (ii) as filtered samples of the prediction subblock that are filtered based on filter coefficients.

In an example, the processing circuitry is configured to determine a BV of another block in the current picture as the refined BV of the first subblock. The first subblock is a closest subblock of subblocks of the current block to the other block. The processing circuitry is configured to determine a prediction block of the other block that is indicated by the determined BV of the other block.

In an example, the processing circuitry is configured to determine a BV of another block in the current picture as a weighted combination of the refined BV of the first subblock and a refined BV of a second subblock. The processing circuitry is configured to determine a prediction block of the other block that is indicated by the determined BV of the other block.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of an intra template matching prediction (IntraTMP) according to some aspects of the disclosure.

FIG. 5 is a schematic illustration of subblock-based IntraTMP according to some aspects of the disclosure.

FIGS. 6A-6E are schematic illustrations of a template of a coding block and subblocks of the coding block.

FIGS. 7A-7E are schematic illustrations of subblock-based IntraTMP via intermediate results of subblock prediction.

FIGS. 8A-8B are schematic illustrations of a first template of a subblock of a coding block.

FIGS. 9A-9B are schematic illustrations of a second template of a subblock of a coding block.

FIGS. 10A-10B are schematic illustrations of a third template of a subblock of a coding block.

FIGS. 11A-11B are schematic illustrations of a partition shape of subblocks in a coding block based on Geometric Partition Mode (GPM).

FIG. 12 shows a flow chart outlining a decoding process according to some aspects of the disclosure.

FIG. 13 shows a flow chart outlining an encoding process according to some aspects of the disclosure.

FIG. 14 is a schematic illustration of a computer system in accordance with an aspect.

### DETAILED DESCRIPTION

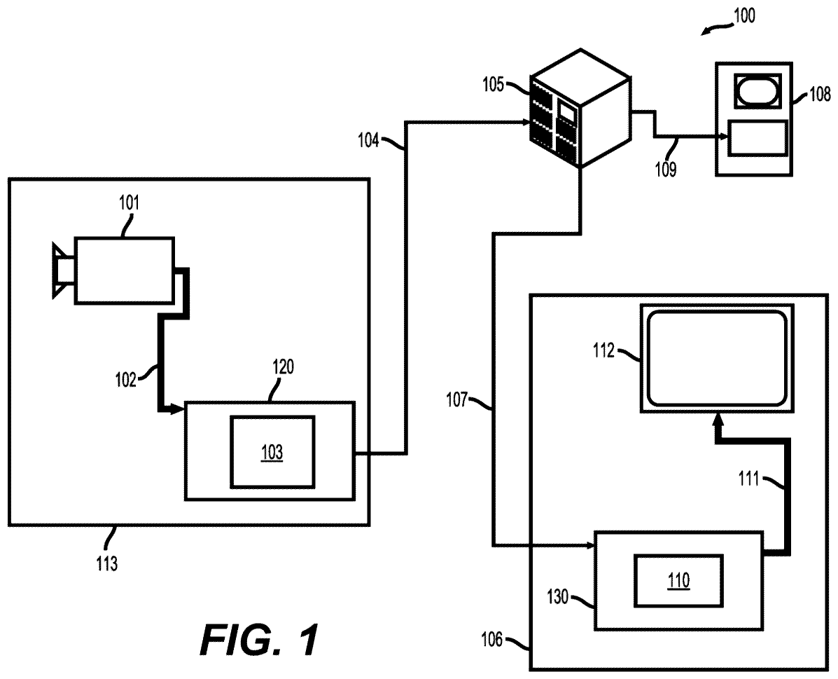

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

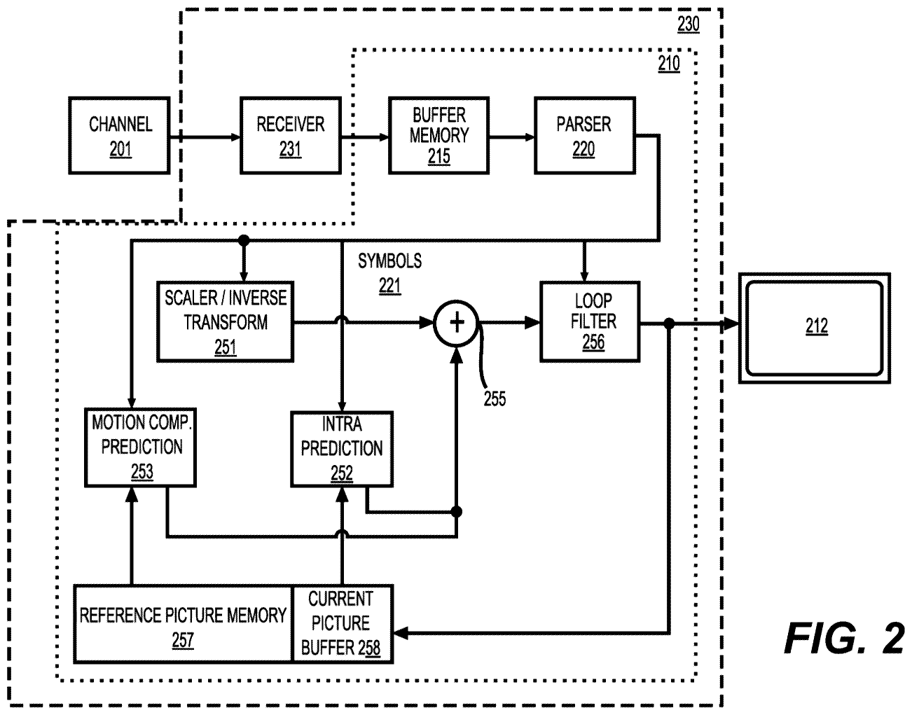

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

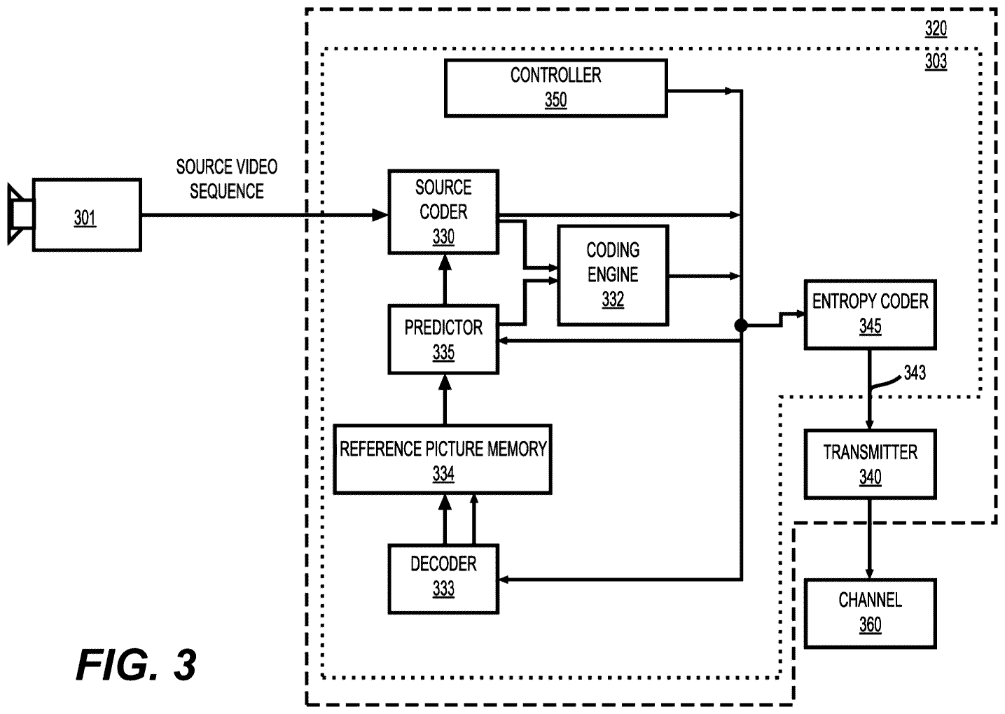

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques for improving a prediction constructed by IntraTMP.

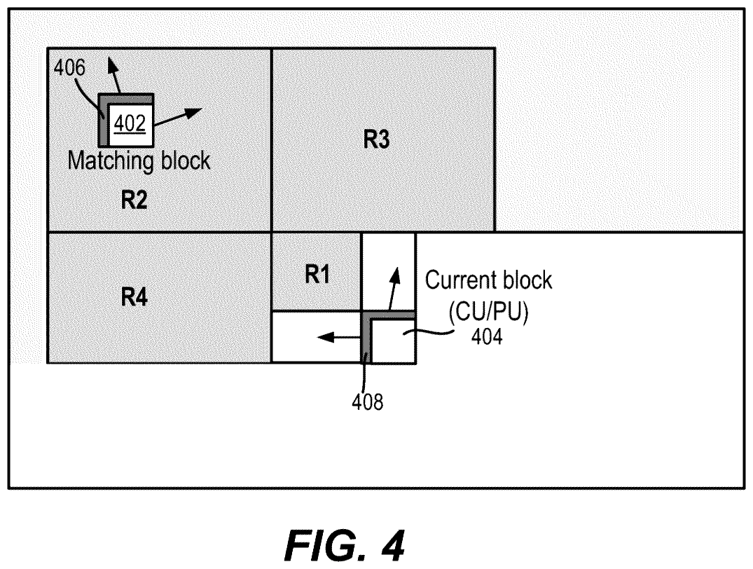

Intra template matching prediction (also referred to as IntraTMP) is a special intra prediction mode that copies a best prediction block from the reconstructed part of the current frame, whose L-shaped template matches the current template (e.g., a template of a current block). For a pre-defined search range, the encoder searches for the most similar template to the current template in a reconstructed part of the current frame and uses the corresponding block as a prediction block, where the most similar template is associated with the corresponding block and the current template is associated with the current block. The encoder then signals the usage of the intraTMP mode, and the same prediction operation can be performed at a decoder side. A matching block (or corresponding block) (402) can be illustrated in FIG. 4 and act as the matching area for the current CU (404).

As shown in FIG. 4, the prediction signal may be generated by matching the L-shaped causal neighbors (or L-shaped template) of the current block (404) with another block in a pre-defined search area. An example of a pre-defined search area may include R1 (a current CTU), R2 (a top-left CTU), R3 (an above CTU), and R4 (a left CTU).

The matching is performed based on a cost function. In an aspect, a sum of absolute differences (SAD) is used as a cost function in IntraTMP mode. Within each search area, the decoder can search for a template (406) of a block (402) that has a least SAD with respect to the current template (408) of the current block (404) and use the block with the least SAD as a corresponding block of the current block. The corresponding block may further act as a prediction block for the current block (404).

The dimensions of all search regions (e.g., SearchRange_w, SearchRange_h) may be set proportional to a block dimension (e.g., BlkW, BlkH) of the current block. Accordingly, a fixed number of SAD comparisons may be obtained in each pixel. For example, the dimensions of a search region (or search range) may be defined in Equations 1 and 2 as follows:

$$SearchRange\_w = a * BlkW \qquad Eq . ( 1 )$$

$$SearchRange\_h = a * BlkH \qquad Eq . ( 2 )$$

where “a” is a constant that controls a trade-off between a gain and a complexity of the search process. In an example, “a” is equal to 5.

In an aspect, to speed-up the template matching process, the search range of all search regions may subsampled by a factor of 2. The reduced search range may lead to a reduction of template matching search by 4. After a best match is found, a refinement process may be further performed. The refinement may be performed via a second template matching search around the best match with a reduced range. The reduced range may be defined as min(BlkW, BlkH)/2.

The Intra template matching tool may be enabled for CUs of certain sizes, such as with a size less than or equal to 64 in a width and a height. A maximum CU size for Intra template matching may be configurable.

In an aspect, the Intra template matching prediction mode may signaled at a CU level through a dedicated flag when decoder-side intra mode derivation (DIMD) is not used for a current CU.

A result of intraTMP for a current block may be a reference block. The reference block may be indicated by a single Block Vector (BV), representing a position of the reference block related to the current coding block. In a current coding block, two or more areas with different textures may exist. It might be difficult to find a single BV to predict/match the current coding block. However, if the current coding block is divided into multiple sub-blocks, the prediction may be easier to predict the multiple sub-blocks based on two or more BVs.

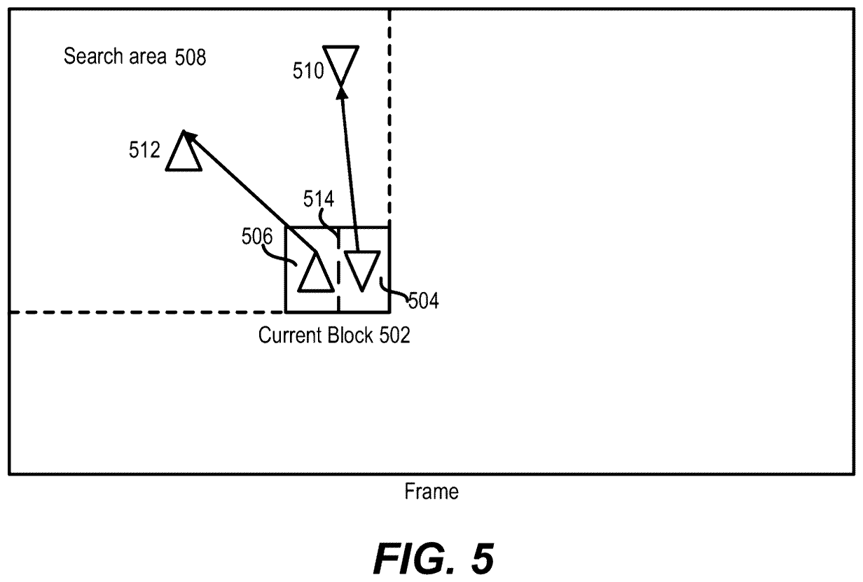

FIG. 5 illustrates an example of intraTMP based on subblocks, where two objects (504) and (506) are included in a current block (502). The two objects, respectively, may have a good match in a search area (508). For example, the object (504) may have a good match (510) and the object (506) may have a good match (512) in the search area (508). However, a large distance between the two objects may prevent an encoder from finding a single good reference block. On the contrary, if the current block could be divided into two sub-blocks by a dashed line (514), such as in a middle of the current block (502), each subblock may find a better match, thus resulting in a better prediction for the whole coding block (502).

To address the issues described in the FIG. 5, various solutions are provided in the disclosure. In a first solution, a sub-block level search refine stage may be applied in the intraTMP. In an aspect, the sub-block level search refine stage may be an additional search stage to an existing two-stage searching approach of the intraTMP. In an example, at a first search stage of the intraTMP, a search may be conducted within a pre-defined subsampled search range (e.g., 2×2 or 3×3 subsampling, 2×2 indicates a search area is down sampled by a half at both a horizontal and a vertical directions) to derive a best (or selected) BV for a block according to a template cost of the intraTMP, noted as BV₁. At a second search stage of the intraTMP, a search may be conducted around the best BV₁ obtained in the 1^{st} stage in a pre-defined search range (e.g., defined as min (BlkW, BlkH)/2, BlkW is a width of the block and BlkH is a height of the block), to obtain a further improved BV, noted as BV₂. At a third search stage of the intraTMP, the proposed subblock level refined search may be performed based on BV₂ (e.g., around BV₂) in a pre-defined search range for a group of pre-defined subblocks (e.g., 8×8 or 4×4) of the block. A final block vector BVₛ may be derived for each subblock of the block. BVₛ may be the same as the BV₂ or may be different from the BV₂. Further, a prediction process may be performed based on the BVₛ. The prediction process may be performed by copying a reference block directly or using an interpolation method based on a sub-pel BV, or other prediction methods to derive a final prediction signal for the block (or subblocks).

In an aspect, an existing second search refine stage of the intraTMP may be replaced with a subblock search refine stage. In an example, in a first search stage of the intraTMP, a search may be conducted within a pre-defined subsampled search range (e.g., 2×2 or 3×3 subsampling) to derive a best (or selected) BV of a block according to a template cost of the intraTMP, noted as BV₁. At a second search stage of the intraTMP, a search may be conducted in a pre-defined search range around the best BV₁ obtained in the 1^{st} stage at a subblock level for a group of pre-defined subblocks (e.g., 8×8 or 4×4) of the block. A final block vector BVₛ at a subblock level may be derived for each subblock of the block. The BVₛ may be the same as the BV₁ or may be different from the BV₁. Further, a prediction process may be performed based on the BVₛ. The prediction process may be conducted by copying a reference block directly, or by using an interpolation method based on a sub-pel BV, or by using other prediction methods to derive a final prediction signal of the block (or subblocks).

In the multi-stage search approach described above, different search precisions may be applied. For example, at the first search stage, integer precisions may be applied on the BV, and for other search stages, fractional BV precisions may be applied.

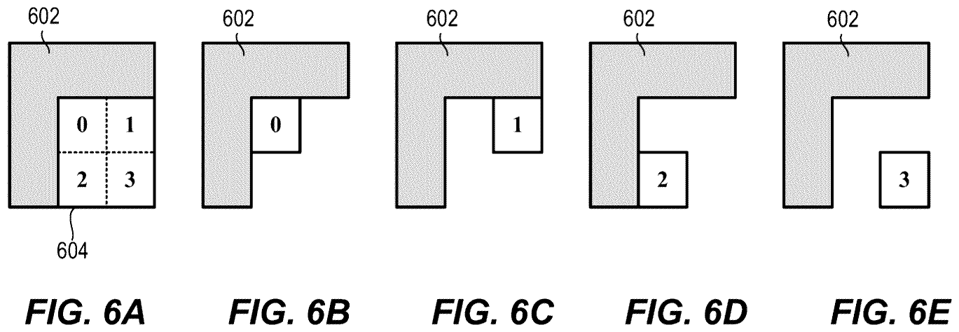

A problem may arise when intraTMP prediction is performed at a subblock level. FIG. 6A shows a L-shaped reference template (602) of a current block (604). The L-shaped reference template (602) may be positioned on a top side and a left side of the current block (604). Samples in the L-shaped reference template area may be reconstructed samples that are available from previous coding blocks. If the L-shaped reference samples are applied to subblocks of the current block (604), some of the subblocks may not have neighboring samples available as a template. FIG. 6A shows an example when the current block (604) is divided into a 2×2 grid to generate 4 subblocks. The subblocks may be indicated with a number 0-3. For a subblock 0, as shown in FIG. 6B, an L-shaped template of the subblock 0 may still be available because the L-shaped template of the subblock 0 can apply the samples in the L-shaped reference template (602). For subblocks 1-3, however, some samples may be missing from L-shaped templates of the subblocks 1-3. For example, as shown in FIG. 6C, for the subblock 1, a left part of the L-shaped template is missing. As shown in FIG. 6D, the subblock 2 may be missing a top part of the L-shaped template. As shown in FIG. 6E, the subblock 3 may be missing both a top and a left parts of the L-shaped template.

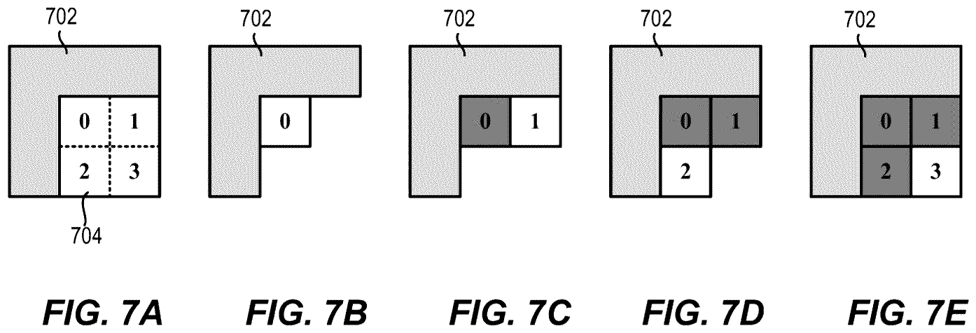

In a second solution, an intermediate reconstructed result of a subblock may be used to predict other subblocks. FIGS. 7A-7E illustrate an example of a sequential intraTMP prediction. As shown in FIG. 7A, a current block (704) can be partitioned into 4 subblocks 0-3. The current block (704) can have an L-shaped template (702). In FIG. 7B, the subblock 0 can be reconstructed based on intraTMP via the L-shaped template (702). For the subblock 1, as shown in FIG. 7C, the subblock 1 may have a missing left template. The missing left template may be derived from the reconstructed samples of the subblock 0 after the subblock 0 is predicted. For example, an inverse transform or other approaches for the subblock 0 may be required to derive a residual signal. Afterwards, the subblock 0 may be reconstructed with a prediction and the residual signal. Other subblocks may reuse intermediate reconstructed samples from previous subblocks in a similar way. For subblock 2, as shown in FIG. 7D, a missing top part of a template of the subblock 2 may be derived from reconstructed samples of the subblocks 0 and 1. For the subblock 3, as shown in FIG. 7E, a missing left part and a missing top part of a template of the subblock 3 may be derived from the subblocks 0, 1, and 2.

It is noted that a search range refine approach in the first solution may be different from the approach in the second solution that applies an entire intraTMP at a block level. In the latter case (or second solution), each subblock may use a brute force method to search in the entire search range such that each possible candidate reference subblock is checked. On the contrary, in the proposed approach in the first solution, the subblock BV may be refined based on a best (or selected) BV that is applies to the entire block. In other words, a better starting BV is derived for refinement in the first solution.

In a third solution, available template information may be used from previous coding blocks to perform predictions of subblocks of a coding block. However, an inverse transform or other approaches to derive a residual signal is postponed until the entire coding block is predicted. For example, as shown in FIG. 7C, for the subblock 1, a template of the subblock 1 may only include samples of the L-shaped template (702) that are on a top side of the subblock 1. For the subblock 2, as shown in FIG. 7D, a template of the subblock 2 may only includes samples of the L-shaped template (702) on a left side of the subblock 2. For the subblock 3, as shown in FIG. 7E, a BV of the subblock 1 and/or the subblock 2 may be reused to predict the subblock 3 or the block level best BV used without subblock level refinement.

After the four subblocks 0-3 are all predicted, an inverse transform (or other approach to derive residual signal) at a block level may be performed. Based on the residual signal at the coding block level and combined prediction signals from a subblock level, reconstructed samples for the whole block (e.g., (704)) may be obtained.

In an aspect, intraTMP may be performed at a subblock level.

In an aspect, a search refinement may be performed after a BV has been derived for an entire coding block.

In an example, a BV for an entire coding block may be denoted as BV₁ with coordinates BV1x, and BV1y. The BV for the entire coding block may be determined based on the intraTMP. For example, the BV may be selected from a plurality of candidate BVs defined in a search range based on template cost values according to the intraTMP. The BV for the entire coding block may be considered as an input. A further refinement search may be performed based on the input BV₁ for a subblock of the coding block. The refinement search may be performed in a search range. The search range may have a top left coordinate as (BV1x−offsetL, BV1y−offsetT) and a bottom right coordinate as (BV1x+offsetR, BV1y+offsetB). The offsetL, the offsetT, the offsetR, and the offsetB may be pre-defined constants. Based on the refined search, an improved (or refined) BVₛ for the considered subblock may be obtained, where a template cost of the improved BVₛ may be reduced to (or correspond to) a minimal template cost in the considered search range. A prediction signal may be obtained using the refined BVₛ at the subblock level.

In an aspect, for each subblock, after the subblock (e.g., the subblock 0 in FIG. 7B) is predicted based on intraTMP to obtain a prediction, a corresponding inverse transform or other alternative approach may be applied to derive a residual signal. For example, the residual signal may be a difference between the subblock and the prediction. The obtained prediction and the derived residual signal at a subblock level may be used to generate reconstructed samples of the subblock. The reconstructed samples of the subblock may be used as a new template for other right and/or bottom subblocks (e.g., the subblock 1 and/or subblock 2 in FIG. 7D). Thus, as shown in FIGS. 6A-6E or FIGS. 7A-7E, a right subblock (e.g., subblock 1) and/or a bottom subblock (e.g., subblock 3) may be missing a part of or all of an L-shaped template due to a block division, the right and/or bottom subblocks may still be coded by intraTMP by using reconstructed samples of neighboring subblocks. In other words, the subblock (e.g., subblock 0 in FIG. 7B) may be a coding unit, a prediction unit, and a transform unit at a same time.

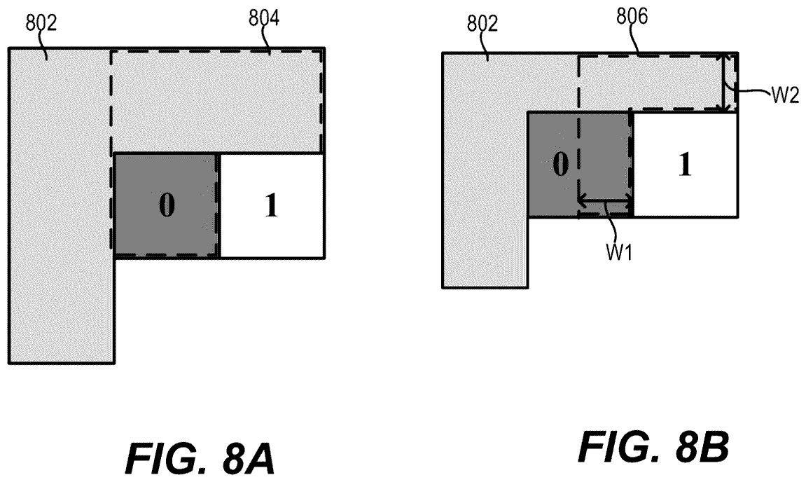

FIG. 8A and FIG. 8B show examples of a template of a subblock based on reconstructed samples of a neighboring subblock. In an example, as shown in FIG. 8A, a subblock 1 may include an L-shaped template (804). The L-shaped template (804) may include reconstructed samples of the subblock 0 that were previously coded and a portion of an L-shaped template (802) of a coding block that includes the subblocks 0-1. In an example, the reconstructed samples of the subblock 0 may be positioned at a first side (e.g., a left side) of the subblock 1, and the portion of the L-shaped template (802) may be positioned at a second side (e.g., a top side) of the subblock 1. In an example, as shown in FIG. 8B, a L-shaped template (806) of the subblock 1 may include a portion of the reconstructed samples of the subblock 0 and a portion of the L-shaped template (802). In an example, a width W1 of the portion of the reconstructed samples of the subblock 0 and a width W2 of the portion of the L-shaped template (802) may be equal. In an example, the width W1 can be a half of a width of the subblock 0.

In an example, a size of an L-Shaped template may be adaptively changed to a subblock level. For example, the L-shaped template of a subblock may only include samples at a left side, a top side, and a top-left side of the subblock, and samples at a top right side and a bottom left side of the subblock may not be included.

In an aspect, a template of a subblock may be adaptively selected based on previous coding blocks but may not reuse intermediate reconstructed samples of the previously coded subblocks. Thus, adjacent reconstructed samples of previous coding blocks may be employed, for example some or as much as possible, to derive the template for a subblock. For example, as shown in FIG. 6C, although the subblock 1 may be missing left samples to have a L-shaped template, top samples are available in the L-shaped template (602). Thus, top samples of the subblock 1 in the L-shaped template (602) may be selected as the template. A similar rule may be applied to the subblock 2, where only left samples of the subblock 2 may be used as a template. For subblock 3, the subblock 3 may use a derived BV of the subblock 1 and/or the subblock 2 to perform the prediction. After all subblocks have been predicted, an inverse transform or other approach to derive a residual signal may be performed at a coding block level (but not at a subblock level). Based on the residual signal at the block level and collective prediction signal at the subblock level, reconstruction samples of the coding block (e.g., (604)) may be derived. Thus, the coding block (e.g., (604)) may be considered as a coding unit as well as a transform unit, but not a prediction unit. Instead, the coding bock may be a collection of a prediction unit at a subblock level.

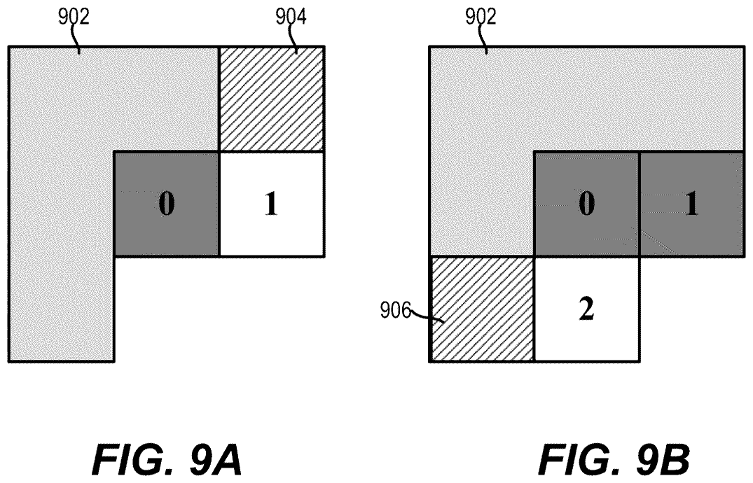

In an example, for subblocks missing a part of an L-shaped template, only direct top/left samples may be considered as a template. For example, as shown in FIG. 9A, for a subblock 1, top left samples of the subblock 1 in an original L-shaped template (902) may not be included as a template of the subblock 1. Only top samples (904) within a width of the subblock 1 in the original L-shaped template (902) may be defined as a template of the subblock 1. For a subblock 2 in FIG. 9B, top-left samples of the subblock 2 in the original L-shaped template (902) may not be included as a template for the subblock 2. Only left samples within a height of the subblock 2 in the original L-shaped template (902) may be defined as the template for subblock 2.

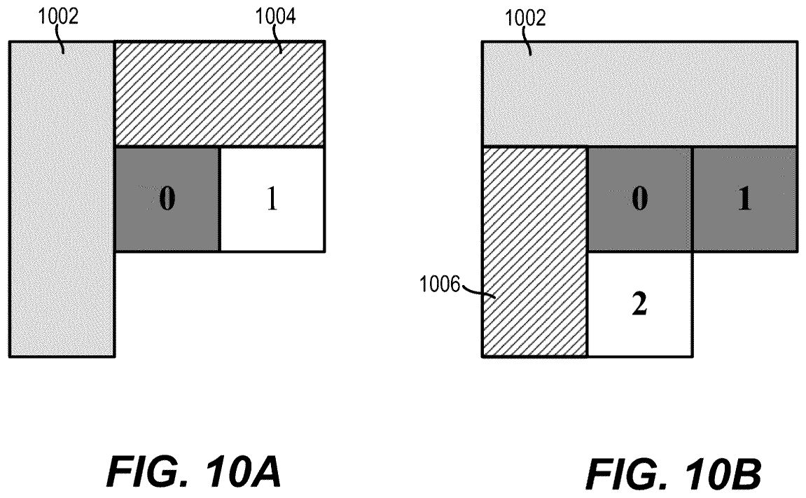

In an example, for a subblock of a coding block missing a part of an L-shaped template, top/left samples of the subblock within a template of the coding block may be considered as a template of the subblock. For example, for a subblock 1 in FIG. 10A, a template (1004) of the subblock 1 may include all top and left samples located in an original L-shaped template (1002) of a coding block that includes the subblocks 0-1. For a subblock 2 in FIG. 10B, a template (1006) of the subblock 2 may include all top and left samples in the original L-shaped template (1002) of the coding block that includes the subblocks 0-2.

In an aspect, a syntax element or other coded information, such as a flag, may be signaled after an intraTMP flag, to indicate whether a specific partition scheme is enabled or not for a considered intraTMP coding block (or a coding block that is considered for intraTMP based on indication of the intraTMP flag).

In an example, only one partition scheme may be allowed.

In an example, a group of partition schemes may be allowed. A combination of disable/enable syntax elements or other coded information, such as flags, may be used to indicate which partition scheme in the group of partition schemes is applied.

In an example, a group of partition schemes may be allowed. An index may be used to indicate which partition scheme of the group of partition schemes is used. The index may be indicated by a syntax element or other coded information.

In an aspect, a search range for a coding block may be adapted to a subblock. For example, for a subblock 1 in FIG. 6C, an allowed maximum sample distance to a left (or a left boundary of the search range) may be reduced by a width of a neighboring subblock 0, such as 4 (or 4 samples), because the subblock 1 may have shifted to the right (or a right side of the L-shaped template (602)) by 4 samples. For the subblock 2 in FIG. 6D, an allowed maximum sample distance to a top (or a top boundary of the search range) may be reduced by 4 (or 4 samples), as subblock 2 may have shifted to a bottom (or a bottom side of the L-shaped template (602)) by 4 samples.

In an aspect, an allowed number of subblocks in a coding block may be N×M, where N is a number of divisions (or partitions) in a horizontal direction and M is a number of divisions (or partitions) at a vertical direction. In an example, as shown in FIG. 6A, N=2 and M=2. However, N and M can be any suitable number.

In an example, N=1 or M=1. In this case, the partition may be aligned with an Intra Sub-Partition (ISP) coding tool, such as the ISP in VVC. The subblock partition for intraTMP may be considered as a harmonization with ISP coding tool.

In an example, a number of subblocks may be adaptive to a coding block size. For example, a fixed size of a subblock may be defined as 8×8 or 4×4. In this case, large coding blocks (for example, larger than or equal to 32×32) may have more subblocks.

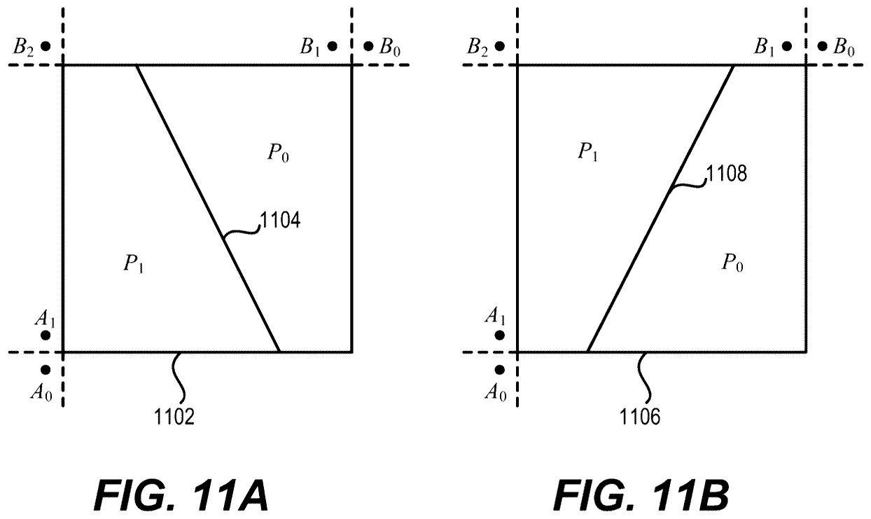

In an aspect, a partition shape may not be limited to a rectangle shape or a square shape. For example, a subblock may be a partition result from other existing coding tools, such as Geometric Partition Mode (GPM), where example partitions of a coding block may be shown in FIGS. 11A and 11B. Furthermore, GPM may not be limited to coding blocks with an inter prediction. The coding blocks may be coded by a combination of inter-intra, or intra-intra. For example, as shown in FIG. 11A, a block (1102) may be partitioned into a partition P0 and a partition P1 by a partition line (1104). The partition P0 can be coded by inter prediction or intra prediction. The partition P1 can be coded by inter prediction or intra prediction. As shown in FIG. 11B, a block (1106) may be partitioned into a partition P0 and a partition P1 by a partition line (1108). The partition P0 can be coded by inter prediction or intra prediction. The partition P1 can be coded by inter prediction or intra prediction.

In an aspect, a division (or size) of a subblock may not be even. A number of samples in each subblock may be different.

In an aspect, each subblock may use multiple candidate reference blocks. A final predictor for each subblock may be derived, such as by using a weighted average of the candidate blocks (also known as fusion method). For example, as shown in FIG. 7B, the subblock 0 may have a plurality of candidate blocks (or candidate prediction blocks) based on intraTMP in a search range. A predictor of the subblock 0 can be determined based on a weighted average of the plurality of candidate prediction blocks.

In an aspect, a refined search range may be set independently for each subblock of a block. In an example, values of offsetL, offsetT, offsetR, offsetB may be different for different subblocks. For example, the values of the offsetL, offsetT, offsetR, offsetB may be different for the subblocks 0-3 in the current block (604).

In an aspect, values of the offsetL, offsetT, offsetR, offsetB may be set independently. Thus, each of the offsetL, offsetT, offsetR, offsetB may be an independently pre-set value.

In an aspect, a refined search range for a subblock, defined by a top left coordinate (BV1x−offsetL, BV1y−offsetT) and a bottom right coordinate (BV1x+offsetR, BV1y+offsetB), may exceed an original (or initial) search range at a coding block level. For example, a search range to determine the BV₁ for the coding block based on the intraTMP may be positioned inside a refined search range for a subblock of the coding block.

In an aspect, a refined search range for a subblock, defined by a top left coordinate (BV1x−offsetL, BV1y−offsetT) and a bottom right coordinate (BV1x+offsetR, BV1y+offsetB), may be restricted to be within an original (or initial) search range at a coding block level. For example, a search range to determine the BV₁ for the coding block based on the intraTMP may include a refined search range for a subblock of the coding block.

In an aspect, a resolution of an input BV (e.g., BV₁) at a coding block and/or an output BV (e.g., BVₛ) at a subblock level may be an integral pel or a sub-pel (e.g., a half-pel or a quarter-pel).

In an aspect, a prediction of a block or a subblock may be obtained through a pixel copy operation, or a filter operation. In the filter operation, a reference block may be set as an input and filter coefficients may be applied on the reference block. The filter coefficients may be pre-defined or trained based on a template of the subblock and a corresponding reference template. In an example, when a BV of a subblock is refined in a search range based on the intraTMP, a reference subblock may be obtained for the subblock based on the refined BV (e.g., BVₛ). A prediction of the subblock may be obtained by coping samples of the reference subblock or using filtered samples of the reference subblock. The filter samples of the reference subblock may be obtained by applying the filter coefficients on the samples of the reference subblock.

In an aspect, the proposed subblock level BV refinement described above may be added to an existing BV search process in the intraTMP at a block level. Accordingly, a BV for a block may be determined in a search range at a block level according to the intraTMP. Block vectors for subblocks of the block may be refined at a subblock level based on respective search ranges of the subblocks. The search ranges of the subblocks may be determined based on the BV of the block. For example, the BV of the block may be defined as a starting BV of a refinement search for a first subblock, and a refinement search range may be defined around the BV of the block.

In an aspect, the proposed subblock level BV refinement described above may replace a refinement search after a coding block BV is derived based on a subsampled search area in the intraTMP.

In an aspect, different BV precisions (e.g., 1-pel, 2-pel, 4-pel, 8-pel, 1/2-pel, ¼-pel, and ⅛-pel) may be applied for different BV refinement search stages. For example, a refinement search for a BV of a block may be at a first BV precision (e.g., an integral pel) and a refinement search for a BV of a subblock at a subblock level may be at a second BV precision (e.g., a sub-pel).

In an aspect, each refined BV of a respective subblock of a current block or selected subblocks of the current block may be used as BV predictors of subsequent coding blocks that are coded after the current block using the intraTMP and/or the intra block copy (IBC) mode. In an example, a refined BV of a subblock of the current block may be inherited as a BV for a subsequent coding block. A positioned-based selection may be applied to define the subblock. For example, a subblock of the current block that is closest to the subsequent coding block may be selected. The refined BV of the selected subblock may be determined as the inherited BV for the subsequent coding block. In an example, refined block vectors of a plurality of subblocks of the current block may be used to determine a BV of a subsequent coding block. A prediction of the subsequent coding block may be a weighted combination of a plurality of reference blocks that are indicated by the refined block vectors of the plurality of subblocks.

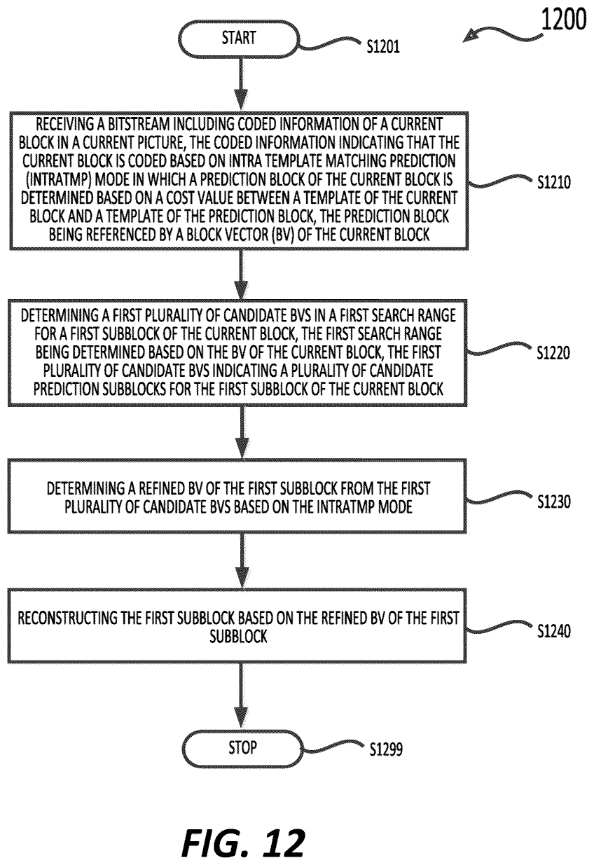

FIG. 12 shows a flow chart outlining a process (1200) according to an aspect of the disclosure. The process (1200) can be used in a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a bitstream including coded information of a current block in a current picture is received. The coded information indicates that the current block is coded based on intraTMP mode in which a prediction block of the current block is determined based on a cost value between a template of the current block and a template of the prediction block, where the prediction block is referenced by a BV of the current block.

At (S1220), a first plurality of candidate BVs is determined in a first search range for a first subblock of the current block. The first search range is determined based on the BV of the current block. The first plurality of candidate BVs indicates a plurality of candidate prediction subblocks for the first subblock of the current block.

At (S1230), a refined BV of the first subblock is determined from the first plurality of candidate BVs based on the intraTMP mode.

At (S1240), the first subblock is reconstructed based on the refined BV of the first subblock.

In an example, a cost value between a template of the first subblock and a template of each of the plurality of candidate prediction subblocks is determined. One of the first plurality of candidate BVs of the first subblock is determined as the refined BV of the first subblock that corresponds to a minimum cost value of the cost values between the template of the first subblock and the templates of the plurality of candidate prediction subblocks that corresponds to the first plurality of candidate BVs of the first subblock.

In an example, the BV of the current block is defined by a first coordinate BVx and a second coordinate BVy, and the first search range is defined by a top left coordinate (BVx−OffsetL1, BV1y−OffsetT1) and a bottom right coordinate (BVx+OffsetR1, BVy+OffsetB1). The OffsetL1, the OffsetT1, the OffestR1, and the OffsetB1 are pre-defined constants.

In an example, a second plurality of candidate BVs is determined in a second search range for a second subblock of the current block, where the second search range is determined based on the BV of the current block. A refined BV of the second subblock is determined from the second plurality of candidate BVs based on the intraTMP, where the second search range is different from the first search range.

In an example, the second search range is defined by a top left coordinate (BVx−OffsetL2, BVy−OffsetT2) and a bottom right coordinate (BVx+OffsetR2, BVy+OffsetB2). The OffsetL2, the OffsetT2, the OffestR2, and the OffsetB2 are pre-defined constants and different from at least one corresponding offset of the first search range.

In an example, the BV of the current block is determined from a plurality of candidate BVs of the current block that is defined in an initial search range according to the intraTMP mode. A boundary of the first search range is beyond a boundary of the initial search range.

In an example, the BV of the current block is defined in an initial search range according to the intraTMP mode, and a boundary of the first search range is within a boundary of the initial search range.

In an example, a resolution of the BV of the current block is at one of a first integral pel and a first sub-pel. A resolution of the BV of the first subblock is at one of a second integral pel and a second sub-pel. The first integral pel includes one of 1-pel, 2-pel, 4-pel, and 8-pel, and the first sub-pel includes one of ½-pel, ¼-pel, and ⅛-pel. The second integral pel includes one of 1-pel, 2-pel, 4-pel, and 8-pel, and the second sub-pel includes one of ½-pel, ¼-pel, and ⅛-pel.

In an example, a prediction subblock of the first subblock is determined from the plurality of candidate prediction subblocks. The prediction subblock of the first subblock is indicated by the refined BV. Reconstructed samples of the first subblock are determined as (i) samples of the prediction subblock of the first subblock or (ii) as filtered samples of the prediction subblock that are filtered based on filter coefficients.

A BV of another block in the current picture is determined as the refined BV of the first subblock. The first subblock is a closest subblock of subblocks of the current block to the other block. A prediction block of the other block that is indicated by the determined BV of the other block is determined.

In an example, a BV of another block in the current picture is determined as a weighted combination of the refined BV of the first subblock and a refined BV of a second subblock. A prediction block of the other block that is indicated by the determined BV of the other block is determined.

Then, the process proceeds to (S1299) and terminates.

The process (1200) can be suitably adapted. Step(s) in the process (1200) can be modified and/or omitted. Additional step(s) can be added. Any suitable order of implementation can be used.

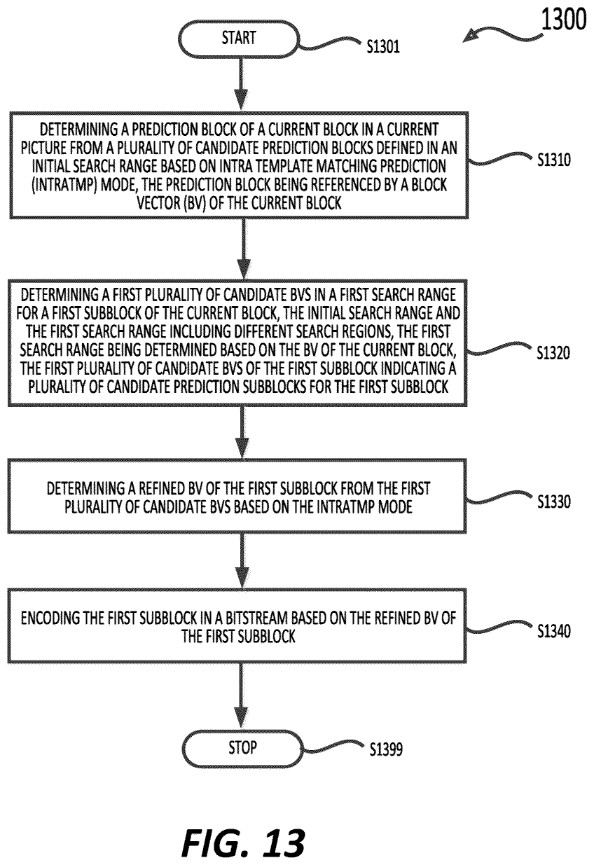

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), a prediction block of a current block in a current picture is determined from a plurality of candidate prediction blocks defined in an initial search range based on intraTMP mode. The prediction block is referenced by a BV of the current block.

At (S1320), a first plurality of candidate BVs is determined in a first search range for a first subblock of the current block. The initial search range and the first search range includes different search regions. The first search range is determined based on the BV of the current block. The first plurality of candidate BVs of the first subblock indicates a plurality of candidate prediction subblocks for the first subblock.

At (S1330), a refined BV of the first subblock is determined from the first plurality of candidate BVs based on the intraTMP mode.

At (S1340), the first subblock is encoded in a bitstream based on the refined BV of the first subblock.

In an example, a cost value between a template of the first subblock and a template of each of the plurality of candidate prediction subblocks is determined. One of the first plurality of candidate BVs of the first subblock is determined as the refined BV of the first subblock that corresponds to a minimum cost value of the cost values between the template of the first subblock and the templates of the plurality of candidate prediction subblocks that corresponds to the first plurality of candidate BVs of the first subblock.

In an example, the BV of the current block is defined by a first coordinate BVx and a second coordinate BVy. The first search range is defined by a top left coordinate (BVx−OffsetL1, BV1y−OffsetT1) and a bottom right coordinate (BVx+OffsetR1, BVy+OffsetB1). The OffsetL1, the OffsetT1, the OffestR1, and the OffsetB1 are pre-defined constants.

In an example, a second plurality of candidate BVs is determined in a second search range for a second subblock of the current block. The second search range is determined based on the BV of the current block. A refined BV of the second subblock is determined from the second plurality of candidate BVs based on the intraTMP mode. The second search range is different from the first search range.

Then, the process proceeds to (S1399) and terminates.

The process (1300) can be suitably adapted. Step(s) in the process (1300) can be modified and/or omitted. Additional step(s) can be added. Any suitable order of implementation can be used.

In the disclosure, a method of processing visual media data is provided. In the method, a bitstream of the visual media data is processed according to a format rule. In an example, the bitstream includes coded information of a current block in a current picture. The coded information indicates that the current block is coded in an intraTMP mode. The format rule specifies that a prediction block of the current block is predicted from a plurality of candidate prediction blocks defined in an initial search range based on the current block being coded in the intraTMP mode. The prediction block is referenced by a block vector (BV) of the current block. The format rule specifies that a first plurality of candidate BVs is determined in a first search range for a first subblock of the current block and a second plurality of candidate BVs is determined in a second search range for a second subblock of the current block. The format rule specifies that the initial search range, the first search range, and the second search range include different search regions. The format rule specifies that the first search range and the second search range are determined based on the BV of the current block. The format rule specifies that the first plurality of candidate BVs of the first subblock indicates a plurality of candidate prediction subblocks for the first subblock. The format rule specifies that the second plurality of candidate BVs of the second subblock indicates a plurality of candidate prediction subblocks for the second subblock. The format rule specifies that a refined BV of the first subblock is determined from the first plurality of candidate BVs based on the intraTMP mode. The format rule specifies that a refined BV of the second subblock is determined from the second plurality of candidate BVs based on the intraTMP mode. The format rule specifies that the first subblock is processed based on the refined BV of the first subblock, and the second subblock is processed based on the refined BV of the second subblock.

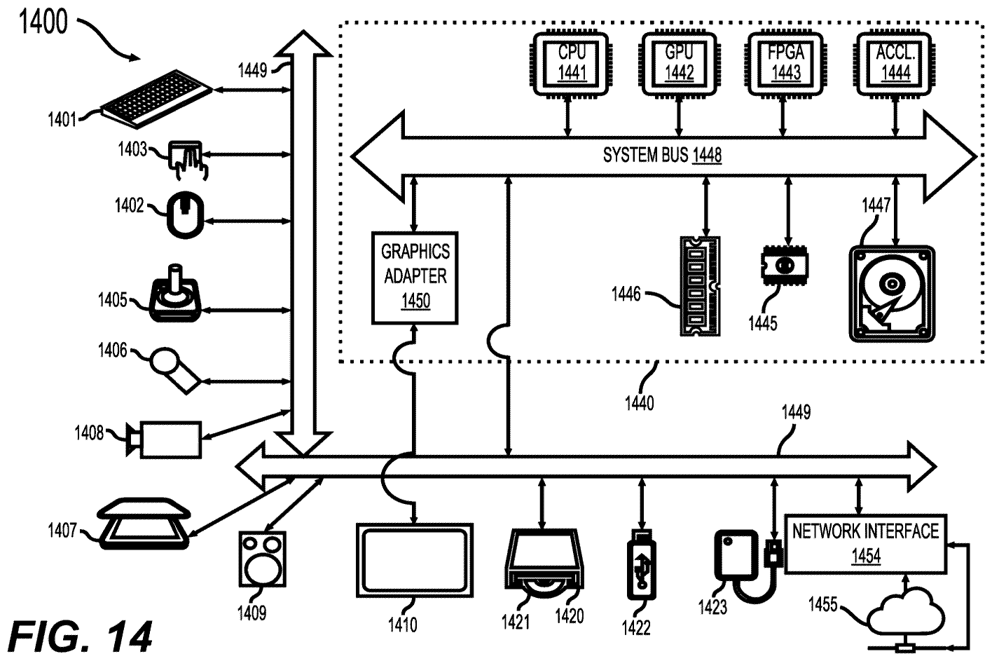

The techniques described above, can be implemented as computer software using computer-readable instructions and physically stored in one or more computer-readable media. For example, FIG. 14 shows a computer system (1400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core's system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various aspects of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding, comprising:
receiving a bitstream including coded information of a current block in a current picture, the coded information indicating that the current block is coded based on intra template matching prediction (intraTMP) mode in which a prediction block of the current block is determined based on a cost value between a template of the current block and a template of the prediction block, the prediction block being referenced by a block vector (BV) of the current block;
determining a first plurality of candidate BVs in a first search range for a first subblock of the current block, the first search range being determined based on the BV of the current block, the first plurality of candidate BVs indicating a plurality of candidate prediction subblocks for the first subblock of the current block;
determining a refined BV of the first subblock from the first plurality of candidate BVs based on the intraTMP mode; and
reconstructing the first subblock based on the refined BV of the first subblock.

2. The method of claim 1, wherein the determining the refined BV further comprises:
determining a cost value between a template of the first subblock and a template of each of the plurality of candidate prediction subblocks; and
determining one of the first plurality of candidate BVs of the first subblock as the refined BV of the first subblock that corresponds to a minimum cost value of the cost values between the template of the first subblock and the templates of the plurality of candidate prediction subblocks that corresponds to the first plurality of candidate BVs of the first subblock.

3. The method of claim 1, wherein:
the BV of the current block is defined by a first coordinate BVx and a second coordinate BVy, and
the first search range is defined by a top left coordinate (BVx−OffsetL1, BV1y−OffsetT1) and a bottom right coordinate (BVx+OffsetR1, BVy+OffsetB1), the OffsetL1, the OffsetT1, the OffestR1, and the OffsetB1 being pre-defined constants.

4. The method claim 3, further comprising:
determining a second plurality of candidate BVs in a second search range for a second subblock of the current block, the second search range being determined based on the BV of the current block; and
determining a refined BV of the second subblock from the second plurality of candidate BVs based on the intraTMP mode, the second search range being different from the first search range.

5. The method of claim 4, wherein:
the second search range is defined by a top left coordinate (BVx−OffsetL2, BVy−OffsetT2) and a bottom right coordinate (BVx+OffsetR2, BVy+OffsetB2), the OffsetL2, the OffsetT2, the OffestR2, and the OffsetB2 being pre-defined constants and different from at least one corresponding offset of the first search range.

6. The method of claim 1, wherein:
the BV of the current block is determined from a plurality of candidate BVs of the current block that is defined in an initial search range according to the intraTMP mode, and
a boundary of the first search range is beyond a boundary of the initial search range.

7. The method of claim 1, wherein:
the BV of the current block is determined from a plurality of candidate BVs of the current block that is defined in an initial search range according to the intraTMP mode, and
a boundary of the first search range is within the boundary of the initial search range.

8. The method of claim 1, wherein:
a resolution of the BV of the current block is at one of a first integral pel and a first sub-pel, a
resolution of the BV of the first subblock is at one of a second integral pel and a second sub-pel,
the first integral pel includes one of 1-pel, 2-pel, 4-pel, and 8-pel, and the first sub-pel includes one of ½-pel, ¼-pel, and ⅛-pel, and
the second integral pel includes one of 1-pel, 2-pel, 4-pel, and 8-pel, and the second sub-pel includes one of ½-pel, ¼-pel, and ⅛-pel.

9. The method of claim 1, wherein the reconstructing further comprises:
determining a prediction subblock of the first subblock from the plurality of candidate prediction subblocks, the prediction subblock of the first subblock being indicated by the refined BV; and
determining reconstructed samples of the first subblock as (i) samples of the prediction subblock of the first subblock or (ii) as filtered samples of the prediction subblock that are filtered based on filter coefficients.

10. The method of claim 1, further comprising:
determining a BV of another block in the current picture as one of (i) the refined BV of the first subblock and (ii) a weighted combination of the refined BV of the first subblock and a refined BV of a second subblock, the first subblock being a closest subblock of subblocks of the current block to the other block; and
determining a prediction block of the other block that is indicated by the determined BV of the other block.

11. A method of video encoding, the method comprising:
determining a prediction block of a current block in a current picture based on intra template matching prediction (intraTMP) mode in which the prediction block of the current block is determined based on a cost value between a template of the current block and a template of the prediction block, the prediction block being referenced by a block vector (BV) of the current block;
determining a first plurality of candidate BVs in a first search range for a first subblock of the current block, the first search range being determined based on the BV of the current block, the first plurality of candidate BVs of the first subblock indicating a plurality of candidate prediction subblocks for the first subblock;
determining a refined BV of the first subblock from the first plurality of candidate BVs based on the intraTMP mode; and
encoding the first subblock in a bitstream based on the refined BV of the first subblock.

12. The method of claim 11, wherein the determining the refined BV further comprises:
determining a cost value between a template of the first subblock and a template of each of the plurality of candidate prediction subblocks; and
determining one of the first plurality of candidate BVs of the first subblock as the refined BV of the first subblock that corresponds to a minimum cost value of the cost values between the template of the first subblock and the templates of the plurality of candidate prediction subblocks that corresponds to the first plurality of candidate BVs of the first subblock.

13. The method of claim 11, wherein:
the BV of the current block is defined by a first coordinate BVx and a second coordinate BVy, and the first search range is defined by a top left coordinate (BVx−OffsetL1, BV1y−OffsetT1) and a bottom right coordinate (BVx+OffsetR1, BVy+OffsetB1), the OffsetL1, the OffsetT1, the OffestR1, and the OffsetB1 being pre-defined constants.

14. The method of claim 13, further comprising:
determining a second plurality of candidate BVs in a second search range for a second subblock of the current block, the second search range being determined based on the BV of the current block; and
determining a refined BV of the second subblock from the second plurality of candidate BVs based on the intraTMP mode, the second search range being different from the first search range.

15. The method of claim 14, wherein:
the second search range is defined by a top left coordinate (BVx−OffsetL2, BVy−OffsetT2) and a bottom right coordinate (BVx+OffsetR2, BVy+OffsetB2), the OffsetL2, the OffsetT2, the OffestR2, and the OffsetB2 being pre-defined constants and different from at least one corresponding offset of the first search range.

16. The method of claim 11, wherein:
the BV of the current block is determined from a plurality of candidate BVs of the current block that is defined in an initial search range according to the intraTMP mode, and
a boundary of the first search range is beyond a boundary of the initial search range.

17. The method of claim 11, wherein:
the BV of the current block is determined from a plurality of candidate BVs of the current block that is defined in an initial search range according to the intraTMP mode, and
a boundary of the first search range is within the boundary of the initial search range.

18. The method of claim 11, wherein:
a resolution of the BV of the current block is at one of a first integral pel and a first sub-pel, a
resolution of the BV of the first subblock is at one of a second integral pel and a second sub-pel,
the first integral pel includes one of 1-pel, 2-pel, 4-pel, and 8-pel, and the first sub-pel includes one of ½-pel, ¼-pel, and ⅛-pel, and
the second integral pel includes one of 1-pel, 2-pel, 4-pel, and 8-pel, and the second sub-pel includes one of ½-pel, ¼-pel, and ⅛-pel.

19. The method of claim 11, wherein the encoding further comprises:
determining a prediction subblock of the first subblock from the plurality of candidate prediction subblocks, the prediction subblock of the first subblock being indicated by the refined BV; and
determining prediction samples of the first subblock as (i) samples of the prediction subblock of the first subblock or (ii) as filtered samples of the prediction subblock that are filtered based on filter coefficients.

20. A non-transitory computer readable medium storing a video media bitstream encoded by an encoding method, the encoding method comprising:
determining a prediction block of a current block in a current picture based on intra template matching prediction (intraTMP) mode in which the prediction block of the current block is determined based on a cost value between a template of the current block and a template of the prediction block, the prediction block being referenced by a block vector (BV) of the current block;
determining a first plurality of candidate BVs in a first search range for a first subblock of the current block, the first search range being determined based on the BV of the current block, the first plurality of candidate BVs of the first subblock indicating a plurality of candidate prediction subblocks for the first subblock;
determining a refined BV of the first subblock from the first plurality of candidate BVs based on the intraTMP mode; and
encoding the first subblock into the video media bitstream based on the refined BV of the first subblock.
